(19) United States
(12) Patent Application Publication
(10) Pub. No.: US 2013/0270086 A1
(43) Pub. Date: Oct. 17, 2013

(54) Shipping Configuration To Reduce Height Of A High Voltage Dead Tank Circuit Breaker

(71) Applicant: ABB TECHNOLOGY AG, Zurich (CH)

(72) Inventors: Beth Dahm, Pittsburgh, PA (US); Matthew Cuppett, Uniontown, PA (US); Jonathan Fuge, Farmington, PA (US)

(73) Assignee: ABB Technology AG, Zurich (CH)

(21) Appl. No.: 13/856,461

(22) Filed: Apr. 4, 2013

Related U.S. Application Data
(60) Provisional application No. 61/623,602, filed on Apr. 13, 2012.

(51) Int. Cl. H01H 31/02

(52) U.S. Cl. CPC H01H 31/026
USPC 200/48 A

(57) ABSTRACT

A pole and actuating assembly for a circuit breaker includes a frame, a plurality of pole and actuating members including a pair of outer pole and actuating members fixed to the frame and a center pole and actuating member disposed there-between and rotatably fixed with respect to the frame. The center pole and actuating member, in an installation position, has a vertical height greater than a vertical height of each of the outer pole and actuating members. Bracket structure is coupled to the frame to permit rotation of the center pole and actuating member to be disposed securely at an acute angle with respect to the frame, thereby reducing the vertical height of the center pole and actuating member in a travel position thereof.

### FIELD

The invention relates to high voltage dead tank circuit breakers and, more particularly, to structure for reducing the height of a center pole and actuating member of a circuit breaker for shipping on a trailer.

### BACKGROUND

Circuit breakers are commonly found in substations and are operable to selectively open and close electrical connections. With reference to FIG. 1, a conventional circuit breaker is shown, generally indicated at 10. Circuit breaker 10 is a three phase circuit breaker, and thus includes three pole assemblies 12a, 12b and 12c. Each pole assembly includes a first electrical conductor 14 carried in a first bushing 16 and a second electrical conductor (not seen) carried in a second bushing. As is known in the art, electrical power lines are coupled to first and second electrical conductors, and the circuit breaker 10 selectively opens or closes the electrical connection there-between. A bell crank 20a, 20b, 20c, is associated with a respective pole assembly 12a, 12b and 12c. The bell cranks are interconnected by a gang-style linkage structure 22 including interconnecting shafts 23 so that all three poles assemblies are actuated at the same time by a single operating mechanism, generally indicated at 24.

In shipping the circuit breaker 10 to its installation location, shipping height becomes an issue since the height H₁ of the center pole assembly 12a (the tallest of the pole assemblies) can be such that the conductors could contact overhead power lines or overpasses. To avoid these issues, the conventional breaker has smaller bushings, or is shipped on a special trailer with the bushings 16 removed. However, to be competitive, a breaker should ship assembled with gas. Customers prefer this method rather than exposing the breaker to the outdoors while installing bushings during commissioning.

Thus, there is a need to provide structure to reduce the shipping height of a dead tank circuit breaker so that the breaker can ship on a single trailer without the need to remove the bushings or to reduce the size of the bushings.

### SUMMARY

An object of the invention is to fulfill the need referred to above. In accordance with the principles of the present invention, this objective is obtained by providing a pole and actuating assembly for a circuit breaker including a frame and a plurality of pole and actuating members including a pair of outer pole and actuating members fixed to the frame and a center pole and actuating member disposed between the outer pole and actuating members and rotatably fixed with respect to the frame. The center pole and actuating member, in an installation position, has a vertical height greater than a vertical height of each of the outer pole and actuating members. Bracket structure is coupled to the frame and is constructed and arranged to permit rotation of the center pole and actuating member to be disposed securely at an acute angle with respect to the frame, thereby reducing the vertical height of the center pole and actuating member in a travel position thereof.

In accordance with another aspect of an embodiment, a dead tank circuit breaker includes a pole and actuating assembly including a plurality of pole and actuating members including a pair of outer pole and actuating members and a center pole and actuating member disposed between the outer pole and actuating members. The center pole and actuating member, in an installation position, has a vertical height greater than a vertical height of each of the outer pole and actuating members. The center pole and actuating member is constructed and arranged to rotate to reduce the vertical height of the center pole and actuating member to be substantially equal to the vertical height of each outer of the outer pole and actuating members in a travel position. The pole and actuating assembly includes linkage structure coupled with each pole and actuating member for actuating an actuator of each member generally simultaneously. Mounting structure is removably mounted to the pole and actuating assembly. An operating mechanism is removably coupled to the linkage structure for operating the linkage structure. In the travel position, the pole and actuating assembly is removed from the mounting structure, the operating mechanism is removed from the linkage structure and the center pole and actuating member is rotated to reduce the vertical height thereof so that the circuit breaker can be shipped to an installation location in one shipment containing the separate pole and actuating assembly, the separate mounting structure, and the separate operating mechanism.

In accordance with another aspect of the disclosed embodiment, a method provides a dead tank circuit breaker for shipment. The circuit breaker has a pole and actuating assembly including a plurality of pole and actuating members including a pair of outer pole and actuating members and a center pole and actuating member disposed between the outer pole and actuating members. The center pole and actuating member, in an installation position, has a vertical height greater than a vertical height of each of the outer pole and actuating members. The center pole and actuating member is constructed and arranged to rotate to reduce the vertical height of the center pole and actuating member to be substantially equal to the vertical height of each outer of the outer pole and actuating members in a travel position. The pole and actuating assembly includes linkage structure coupled with each pole and actuating member for actuating an actuator of each member generally simultaneously. The method provides the pole and actuating assembly separated from a mounting structure. The mounting structure, when coupled to the pole and actuating assembly, supports the pole and actuating assembly. An operating mechanism is separated from the linkage structure. The operating mechanism, when coupled to the linkage structure, operates the linkage structure. The center pole and actuating member is rotated to the travel position to reduce the vertical height thereof, permitting the circuit breaker to be shipped to an installation location in one shipment containing the separated pole and actuating assembly, the separated mounting structure, and the separated operating mechanism.

Other objects, features and characteristics of the present invention, as well as the methods of operation and the functions of the related elements of the structure, the combination of parts and economics of manufacture will become more apparent upon consideration of the following detailed description and appended claims with reference to the accompanying drawings, all of which form a part of this specification.

### BRIEF DESCRIPTION OF THE DRAWINGS

The invention will be better understood from the following detailed description of the preferred embodiments thereof, taken in conjunction with the accompanying drawings, wherein like reference numerals refer to like parts, in which:

FIG. 1 is a side view of a conventional high voltage circuit breaker.

FIG. 2 is side view of a pole and actuating assembly and bracket structure of a circuit breaker, in accordance with an embodiment, shown with the center pole and actuating member in a rotated, travel position.

FIG. 3 is an enlarged view of the bracket structure of FIG. 2 associated with the center pole and actuating member.

FIG. 4 shows the pole and actuating assembly of FIG. 2 mounted on a double drop trailer, with a remainder of the circuit breaker being carried at rear portion of the trailer.

FIG. 5 is a view of the circuit breaker of FIG. 4 re-assembled at an installation location.

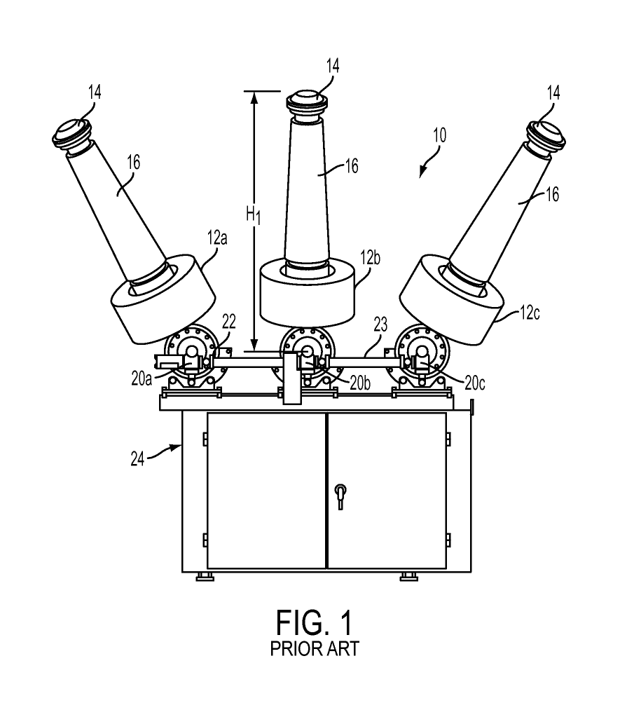

### DETAILED DESCRIPTION OF AN EXEMPLARY EMBODIMENT

The circuit breaker 10′ described herein can be of the type disclosed in U.S. Patent Publication No. 2010/0270136 A1, published on Oct. 28, 2010, the content of which is hereby incorporated by reference into this specification.

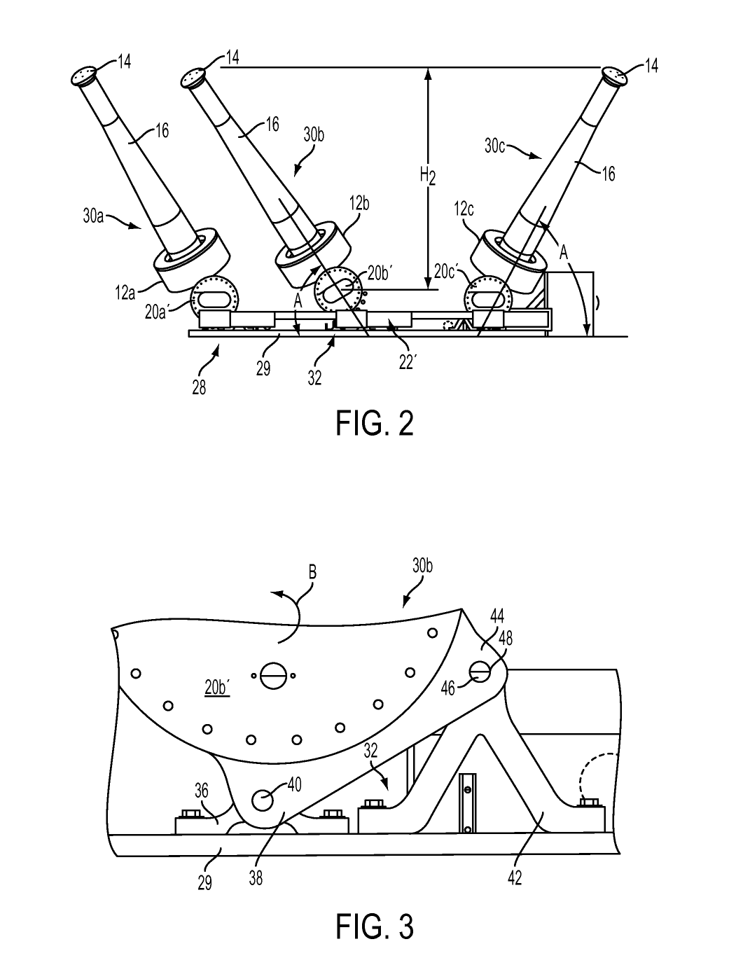

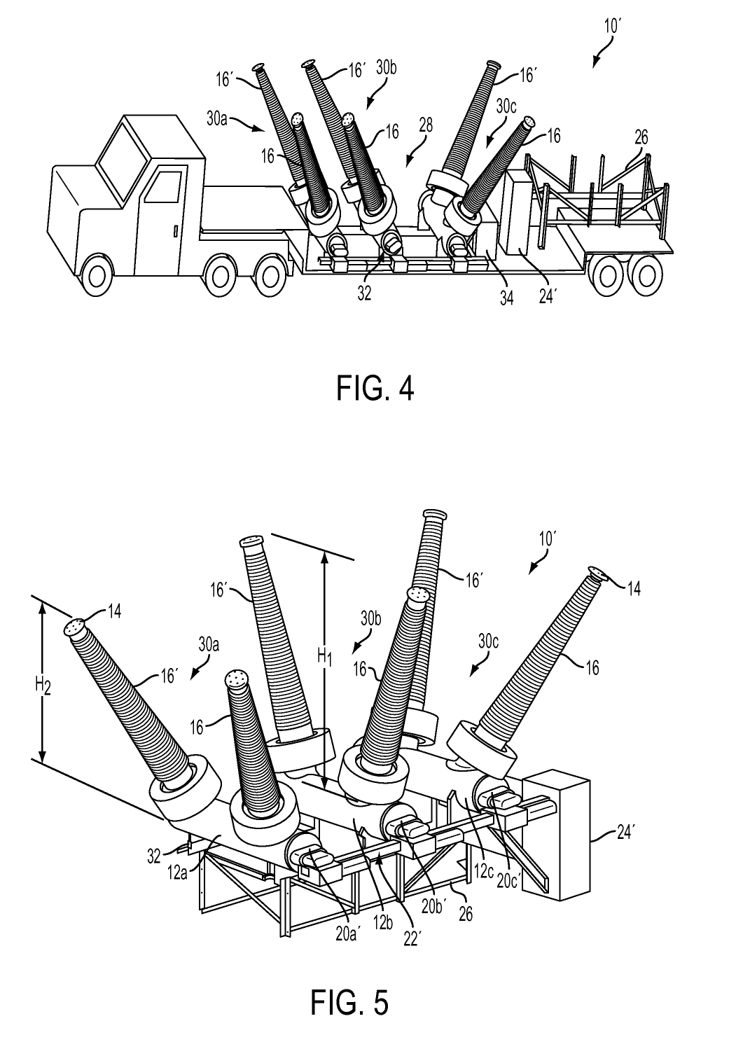

With reference to FIGS. 2-5, when the operating mechanism 24′ and mounting structure 26 (FIGS. 4 and 5) are removed from the circuit breaker 10′, a pole and actuating assembly, generally indicated at 28 in FIG. 2, remains. The pole and actuating assembly 28 includes the three pole assemblies 12a, 12b, 12c, each having a pair of bushings 16, 16′, and an actuator, preferably in the form of a bell crank 20a′, 20b′, 20c′, coupled with a respective pole assembly 12a, 12b, 12c. Each pole assembly and coupled bell crank defines a pole and actuating member 30a, 30b, 30c, respectively. The assembly 28 includes the linkage structure 22′ coupling the bell cranks so as to actuate the bell cranks generally simultaneously when operated by the operating mechanism 24′ coupled with the linkage structure 22′. The assembly 28 also includes a support frame 29. The outer two pole and actuating members 30a, 30c are rotated and fixed at opposite, acute angles A to achieve proper spacing.

Although removing the assembly 28 from the remainder of the circuit breaker 10′ significantly reduces the overall height of the circuit breaker 10′ for shipping, the center pole and actuating member 30b is disposed at generally at a 90° angle and thus has a vertical height H₁ greater than the vertical height H₂ of the outer pole and actuating members 30a, 30c in an installation position (see FIG. 5 for H₁ and H₂). Thus, the center pole and actuating member 30b may still cause interference issues with power lines or overpasses during shipping.

With reference to FIG. 2, bracket structure, generally indicated at 32, is provided to permit the center pole and actuating member 30b to rotate to a travel position towards one of the outer pole and actuating members 30a or 30c to reduce the vertical height H₂ thereof so as to be substantially equal to the vertical height of the outer pole and actuating members 30a, 30c. Thus, due to rotating the central pole and actuating member 30b, H₂ is less than H₁ (FIG. 5), and substantially equal to the vertical height of the outer pole and actuating members 30a and 30c.

As best shown in FIG. 3, the bracket structure 32 is mounted to the frame 29. The frame 29 can be secured to a trailer 34 (FIG. 4). In the embodiment, the bracket structure 32 includes a first bracket 36 coupled to one end 38 of the bell crank 20b′ at pivot connection 40 and a second bracket 42 coupled to another end 44 of the bell crank 20b′ by a removable fastener 46. Thus, prior to shipping of the circuit breaker 10′ the pole and actuating member 30b is pivoted about pivot connection 40 in the direction of arrow B, rotating end 44 until an opening 48 therein aligns with an opening in the bracket 42. Once aligned, a fastener 46 such as a pin or bolt is passed through the openings securing the end 44 to the bracket 42. The location (e.g., height) of fastener 46 ensures that upon rotation of the pole and actuating member 30b, the travel position height H₂ thereof is achieved due to being disposed at acute angle A with respect to the frame 29. Although the bracket structure 32 includes first and second brackets, the bracket structure can comprise an integral or single structure.

With reference to FIG. 4, the frame 29, supporting the pole and actuating assembly 28 is mounted on a front portion of a double drop trailer 34, with the center pole and actuating member 30b rotated and secured in the travel position. The operating mechanism 24′ and mounting structure 26 are mounted to a rear portion of the trailer 34 so that the entire circuit breaker 10′, in three separate pieces, can be shipped to the installation location by one trailer and one vehicle without escorts. This arrangement significantly reduces the shipping cost of a dead tank circuit breaker. Furthermore, since the bushings 16, 16′ need not be removed; the circuit breaker 10′ can be shipped assembled with gas.

Once shipped to the installation location, fastener 46 can be removed and the pole and actuating member 30b can be rotated in a direction opposite arrow B to its generally vertical, 90° installation position (height H₁ in FIG. 5) and then can be secured in that position. The frame 29, with the pole and actuating assembly 28 thereon, can then be mounted to the mounting structure 26 by bolting or the like and the operating mechanism 24′ can be coupled to the linkage structure 22 to re-assemble the circuit breaker 10′ at the installation location, as shown in FIG. 5.

The foregoing preferred embodiments have been shown and described for the purposes of illustrating the structural and functional principles of the present invention, as well as illustrating the methods of employing the preferred embodiments and are subject to change without departing from such principles.

Therefore, this invention includes all modifications encompassed within the spirit of the following claims.

What is claimed is:

1. A pole and actuating assembly for a circuit breaker, the assembly comprising:
a frame,
a plurality of pole and actuating members including a pair of outer pole and actuating members fixed to the frame and a center pole and actuating member disposed between the outer pole and actuating members and rotatably fixed with respect to the frame, the center pole and actuating member, in an installation position, having a vertical height greater than a vertical height of each of the outer pole and actuating members, and
bracket structure coupled to the frame and constructed and arranged to permit rotation of the center pole and actuating member to be disposed securely at an acute angle with respect to the frame, thereby reducing the vertical height of the center pole and actuating member in a travel position thereof.

2. The assembly of claim 1, wherein the bracket structure is coupled to one portion of the center pole and actuating member by a pivot connection so as to permit the rotation of the center pole and actuating member to the travel position so as to have a vertical height substantially equal to the vertical height of each of the outer pole and actuating members.

3. The assembly of claim 2, wherein the bracket structure is constructed and arranged to be removably fixed to the center pole and actuating member to secure the center pole and actuating member in the travel position.

4. The assembly of claim 3, further comprising a fastener for removably fixing the center pole and actuating member to the bracket structure.

5. The assembly of claim 1, wherein each pole and actuating member comprises a pole assembly having a pair of bushings, and a bell crank coupled to the pole assembly.

6. The assembly of claim 5, wherein the bracket structure is coupled to the bell crank of the center pole and actuating member by a pivot connection so as to permit the rotation of the center pole and actuating member to the travel position.

7. The assembly of claim 6, wherein the bracket structure is constructed and arranged to be removably fixed to the bell crank of the center pole and actuating member to secure the center pole and actuating member in the travel position.

8. The assembly of claim 5, in combination with the circuit breaker, wherein the pole and actuating assembly includes linkage structure operatively associated with each bell crank, the circuit breaker having a mounting structure for supporting the pole and actuating assembly and an operating mechanism for controlling movement of the linkage structure.

9. The combination of claim 9, wherein the operating mechanism is constructed and arranged to be removably coupled to the linkage structure, and the frame is constructed and arranged to be removably coupled to the mounting structure so that the circuit breaker can be shipped to an installation location in one shipment containing the separate pole and actuating assembly, the separate mounting structure, and the separate operating mechanism.

10. A dead tank circuit breaker comprising:
a pole and actuating assembly comprising:
a plurality of pole and actuating members including a pair of outer pole and actuating members and a center pole and actuating member disposed between the outer pole and actuating members, the center pole and actuating member, in an installation position, having a vertical height greater than a vertical height of each of the outer pole and actuating members, the center pole and actuating member being constructed and arranged to rotate to reduce the vertical height of the center pole and actuating member to be substantially equal to the vertical height of each outer of the outer pole and actuating members in a travel position, and
linkage structure coupled with each pole and actuating member for actuating an actuator of each member generally simultaneously,
mounting structure removably mounted to the pole and actuating assembly, and
an operating mechanism removably coupled to the linkage structure for operating the linkage structure,
whereby in the travel position, the pole and actuating assembly is removed from the mounting structure, the operating mechanism is removed from the linkage structure and the center pole and actuating member is rotated to reduce the vertical height thereof so that the circuit breaker can be shipped to an installation location in one shipment containing the separate pole and actuating assembly, the separate mounting structure, and the separate operating mechanism.

11. The circuit breaker of claim 10, wherein the pole and actuating assembly further comprises a frame and a bracket structure coupled to the frame, the bracket structure being constructed and arranged to permit rotation of the center pole and actuating member to be disposed securely at an acute angle with respect to the frame, thereby reducing the vertical height of the center pole and actuating member in the travel position.

12. The circuit breaker of claim 11, wherein the bracket structure is coupled to one portion of the center pole and actuating member by a pivot connection so as to permit the rotation of the center pole and actuating member to the travel position.

13. The circuit breaker of claim 12, wherein the bracket structure is constructed and arranged to be removably fixed to the center pole and actuating member to secure the center pole and actuating member in the travel position.

14. The circuit breaker of claim 13, further comprising a fastener for removably fixing the center pole and actuating member to the bracket structure.

15. The circuit breaker of claim 10, wherein each pole and actuating member comprises a pole assembly having a pair of bushings, and a bell crank, defining the actuator, coupled to the pole assembly.

16. A method of providing a dead tank circuit breaker for shipment, the circuit breaker having a pole and actuating assembly comprising a plurality of pole and actuating members including a pair of outer pole and actuating members and a center pole and actuating member disposed between the outer pole and actuating members, the center pole and actuating member, in an installation position, having a vertical height greater than a vertical height of each of the outer pole and actuating members, the center pole and actuating member being constructed and arranged to rotate to reduce the vertical height of the center pole and actuating member to be substantially equal to the vertical height of each outer of the outer pole and actuating members in a travel position, and linkage structure coupled with each pole and actuating member for actuating an actuator of each member generally simultaneously, the method comprising:
providing the pole and actuating assembly separated from a mounting structure, the mounting structure, when coupled to the pole and actuating assembly, supporting the pole and actuating assembly,
providing an operating mechanism separated from the linkage structure, the operating mechanism, when coupled to the linkage structure, operates the linkage structure, and
rotating the center pole and actuating member to the travel position to reduce the vertical height thereof, permitting the circuit breaker to be shipped to an installation location in one shipment containing the separated pole and actuating assembly, the separated mounting structure, and the separated operating mechanism.

17. The method of claim 16, wherein the pole and actuating assembly further comprises a frame and a bracket structure coupled to the frame, the bracket permitting the rotation of the center pole and actuating member so as to be disposed securely at an acute angle with respect to the frame, thereby reducing the vertical height of the center pole and actuating member in the travel position.

18. The method of claim 17, wherein the rotating step includes using a pivot connection between the bracket structure and the center pole and actuating member.
